(19) United States
(12) Patent Application Publication
(10) Pub. No.: US 2007/0221576 A1
(43) Pub. Date: Sep. 27, 2007

(54) Static Head Reverse Osmosis

(76) Inventor: Brian Douglas Parkinson, Gold Coast MC (AU)

Correspondence Address: WILLIAMS MULLEN, 222 CENTRAL PARK AVENUE, SUITE 1700, VIRGINIA BEACH, VA, 23462-3035, US

(21) Appl. No.: 11/579,229

(22) PCT Filed: Jan. 31, 2005
(86) PCT No.: PCT/AU05/00114

§ 371 Date: Oct. 30, 2006

(30) Foreign Application Priority Data
Apr. 30, 2004 (AU) 2004902262
Oct. 7, 2004 (AU) 2004905782

(51) Int. Cl. B01D 61/02; B01D 63/00

(52) U.S. Cl. 210/652; 210/500.21

(57) ABSTRACT

Apparatus for reverse osmosis using static pressure head including: reverse osmosis plant operable to produce a permeate and a concentrate (hereinafter referred to as a “brine”) from a feedstock, the feedstock being supplied to the reverse osmosis plant via a feedstock conduit from a feedstock source; static pressure head means operatively associated with the reverse osmosis plant; permeate removal means in fluid connection with the reverse osmosis plant for removing permeate from the reverse osmosis plant; brine removal means in fluid connection with the reverse osmosis plant for removing at least some of the brine from the reverse osmosis plant to a brine removal location, and wherein the static pressure head means is provided by locating the reverse osmosis plant, the feedstock source and the brine removal location at relative altitude differences for generating a static pressure head in the reverse osmosis plant; the permeate removal means is located whereby, in use, permeate may be removed to provide a trans-membrane pressure drop sufficient for reverse osmosis of the feedstock across the membrane or membranes of the reverse osmosis plant; the location of the brine removal means with respect to the reverse osmosis plant and the feedstock is selected such that, in use, the brine removal means may be operated to provide flow of the feedstock sufficient for the generation of an operable fluid velocity across the membrane surface of the reverse osmosis plant.

### FIELD OF INVENTION

THIS INVENTION relates to static head reverse osmosis. More particularly, the invention relates to apparatus and a method for production of reverse osmosis permeate from a feedstock delivered to reverse osmosis plant taking advantage of the existence of static pressure head as a consequence of location of processing elements at different elevations. The invention has particular application to the production of desalinated or potable water from saline or brackish feed water, but is not limited to this field of use.

### BACKGROUND ART

Reverse osmosis has been used from time to time as a method of separating a solvent from one or more dissolved solutes, particularly solutes being dissolved in ionic solution. In order to drive the reverse osmosis process, relatively high pressures are required. That is, operating pressures for the reverse osmosis process are significantly higher than for other pressure driven separation processes.

Hydrostatic pressure has been used in waste-water treatments systems where discharge of effluent into receiving waters is at an altitude sufficiently lower than the altitude of the influent feedstock. Such systems are limited to the traditional waste-water treatment unit operations such as sand filtration, trickle-bed filtration, membrane microfiltration and the like. Reverse osmosis for the production of potable water usually includes high pressure, high volume pumps in order to generate the required pressure and flow conditions for reverse osmosis to take place.

It has been asserted that the world will face a water crisis within a few decades from now as a result of population growth, pollution and climate change. It has been suggested that by 2050, between two billion people in 48 countries and up to seven billion people in 60 countries will face scarcity of fresh water. The supply of fresh water is finite and limited. Moreover, it now appears that climate changes may combine with the above to create a scarcity in the availability of water of suitable quality.

Solutions proposed to remedy the dwindling availability of water typically involve conventional technologies such as the construction of dams and water storage facilities and extraction of groundwater. The conventional schemes are sometimes augmented by water conservation programs and devices and/or the construction of new pipelines to minimise waste losses. However, water conservation techniques and construction of new or enlarged water storage facilities are both limited by the yield of water which may be captured and recovered relative to the growth in demand by an ever increasing population. Water conservation may have some impact on short term demand but in the longer term the limited volume of captured water will not be adequate to meet demand.

The oceans contain an abundant water supply provided its salinity can be removed. The capture and storage of fresh water from precipitation remains the preferred option for today for most of the world due to the high capital and operation cost of the current desalination processes. The methods for removing salt from salt water (desalination) include distillation, crystallisation, electro dialysis, and reverse osmosis. The main disadvantage of the current methods is that large amounts of energy are required to power the desalination process. The generation of the power in turn creates other detrimental environmental impacts.

Several systems have been proposed in which apparatus may be dropped overboard from a marine vessel. The apparatus includes a reverse osmosis membrane arranged for contact with the waters into which the apparatus is dropped, and a chamber for receiving permeate. As the apparatus is lowered, the hydrostatic pressure on the membrane increases such that, when sufficient depth is achieved, and/or sufficient time is provided, the permeate chamber may be filled or partially filled. The apparatus may then be withdrawn to the surface and the permeate retrieved from the permeate chamber. Such apparatus is quite adequate for small volumes of fresh water that may be required for a small ocean-going vessel. Scale-up of such apparatus for water production at industrial quantities is generally not a viable proposition.

A desalination method which is both relatively efficient in extracting usable water from the saline (salt) water stored in the oceans and other saline water bodies which also minimises the consumption of power may ultimately be the preferred source of fresh water. Minimisation of power requirements in conjunction with improvements in materials and hydrodynamic technology may reduce unit and operational costs to a level sufficient to provide an adequate source of water for consumption and other uses, possibly for centuries to come.

The present invention aims to provide apparatus and a method for reverse osmosis using static pressure head and which alleviates one or more of the inefficiencies or disadvantages of the prior art. The present invention also aims to provide a more cost effective solution than has been provided in prior art reverse osmosis systems. The present invention also aims to provide apparatus and a method for reverse osmosis using static pressure head which addresses the anticipated future water supply issues, or at least makes a contribution to solving the aforementioned water supply problems. Other aims and advantages of the invention may become apparent from the following description.

### DISCLOSURE OF THE INVENTION

With the foregoing in view, this invention in one aspect resides broadly in apparatus for reverse osmosis using static pressure head including:

reverse osmosis plant operable to produce a permeate and a concentrate (hereinafter referred to as a “brine”) from a feedstock, the feedstock being supplied to the reverse osmosis plant via a feedstock conduit from a feedstock source;

static pressure head means operatively associated with the reverse osmosis plant;

permeate removal means in fluid connection with the reverse osmosis plant for removing permeate from the reverse osmosis plant;

brine removal means in fluid connection with the reverse osmosis plant for removing at least some of the brine from the reverse osmosis plant to a brine removal location, and wherein
the static pressure head means is provided by locating the reverse osmosis plant, the feedstock source and the brine removal location at relative altitude differences for generating a static pressure head in the reverse osmosis plant;
the permeate removal means is located whereby, in use, permeate may be removed to provide a trans-membrane pressure drop sufficient for reverse osmosis of the feedstock across the membrane or membranes of the reverse osmosis plant;
the location of the brine removal means with respect to the reverse osmosis plant and the feedstock is selected such that, in use, the brine removal means may be operated to provide flow of the feedstock sufficient for the generation of an operable fluid velocity across the membrane surface of the reverse osmosis plant.

In another aspect, the present invention resides broadly in a method of reverse osmosis using static pressure head including:

providing a feedstock from a feedstock supply in fluid connection with a reverse osmosis plant, at least some of the feedstock passing through the reverse osmosis plant as permeate and remainder of the feedstock being removed as concentrate to a concentrate delivery in fluid connection with the reverse osmosis plant;

providing a static pressure head in the feedstock and the concentrate by locating the fluid connections between the feedstock and the concentrate and the reverse osmosis plant at respective locations which are vertically displaced from one the feedstock supply and the concentrate delivery a distance sufficient to permit the generation of a transmembrane pressure drop for reverse osmosis;

removing the permeate from the reverse osmosis plant in such manner as to provide the transmembrane pressure drop and;

returning at least some of the concentrate to the feedstock.

In another aspect, the present invention resides broadly in a method of reverse osmosis using static pressure head including:

providing a feedstock from a feedstock supply in fluid connection with a reverse osmosis plant, at least some of the feedstock passing through the reverse osmosis plant as permeate and the remainder of the feedstock being removed as concentrate to a concentrate delivery in fluid connection with the reverse osmosis plant;

providing a static pressure head in the feedstock and the concentrate by locating the fluid connections between the feedstock and the concentrate and the reverse osmosis plant at respective locations which are vertically displaced from one the feedstock supply and the concentrate delivery a distance sufficient to permit the static pressure head to contribute to pressure required for the generation of a transmembrane pressure drop for reverse osmosis;

removing the permeate from the reverse osmosis plant in such manner as to provide the transmembrane pressure drop; and

returning at least come of the concentrate to the feedstock.

The feedstock includes saline and/or impure water. The brine removal means may remove all of the brine from the reverse osmosis plant. The location of the brine removal means may also be selected for generating part or all of a back pressure within the reverse osmosis plant.

Preferably, the static pressure head is provided by locating the reverse osmosis plant in an earth cavity, such as a well, mine shaft, pit or the like at a depth below ground level or the effective level of the feedstock sufficient to provide the transmembrane pressure differential to drive a reverse osmosis process. In this specification, terms such as “ground level”, “surface level” or the like are to be taken to include a reference to a hydraulic potential energy line of the feedstock covering elevated and depressed altitudes with respect to ground level, unless the context requires otherwise. It is preferred that the depth is sufficient to provide substantially all of the pressure head required for the reverse osmosis process. However, in locations where sufficient depth is inconvenient or unavailable, the static pressure head may be used to assist with the generation of sufficient operating pressure by conventional means. Alternatively, means for intensifying pressure may be employed, such as a work or energy exchanger or the like, hydraulic ram or the like. Energy recovery may be applied to the permeate outflow to provide pressure for additional reverse osmosis or other processing of permeate, concentrate or brine and feedstock.

Preferably, the brine is pumped from the earth cavity by a pump located below the ground level, the depth being selected according to the pumping characteristics of the selected pump. The permeate is pumped from the reverse osmosis plant whereby a pressure differential across the membrane is produced. The permeate pump may be located at the level of the reverse osmosis plant for convenience, but may be located at a different level. It will be appreciated that transmembrane pressure drop is one of the important parameters to be established by the location of the reverse osmosis plant, the location and specification of the permeate pump, and that surface velocity is one of the important parameters to be established by the brine pump. The pumps are selected for operation of the reverse osmosis plant according to established operating criteria for reverse osmosis plants.

Permeate and/or brine may be stored below the ground level for delivery to the surface or consumer storage on intermittent basis or the like. The basis for delivery may, for example, be dependant on availability of power, or to take advantage of off-peak power rates.

Recycling and/or cascading of reverse osmosis units may be utilised to increase concentration of the brine and/or decrease the concentration of ionic species in the permeate in accordance with established reverse osmosis processing principles. Various elements and minerals in the brine may be recovered using additional recovery processes if by the concentration by reverse osmosis such recovery becomes an economic proposition. The nature of the process, system and method requires a small land surface footprint. Energy for the operation of the pumps, valves, controls and the like of the apparatus of the present invention may be from any source.

### BRIEF DESCRIPTION OF THE DRAWINGS

In order that the invention may be more readily understood and put into practical effect, reference will now be made to the accompanying drawings which illustrate a preferred embodiment of the invention and wherein:—

FIG. 1 is a schematic diagram illustrating apparatus for reverse osmosis using hydrostatic pressure head according to the invention.

### DETAILED DESCRIPTION OF THE DRAWINGS

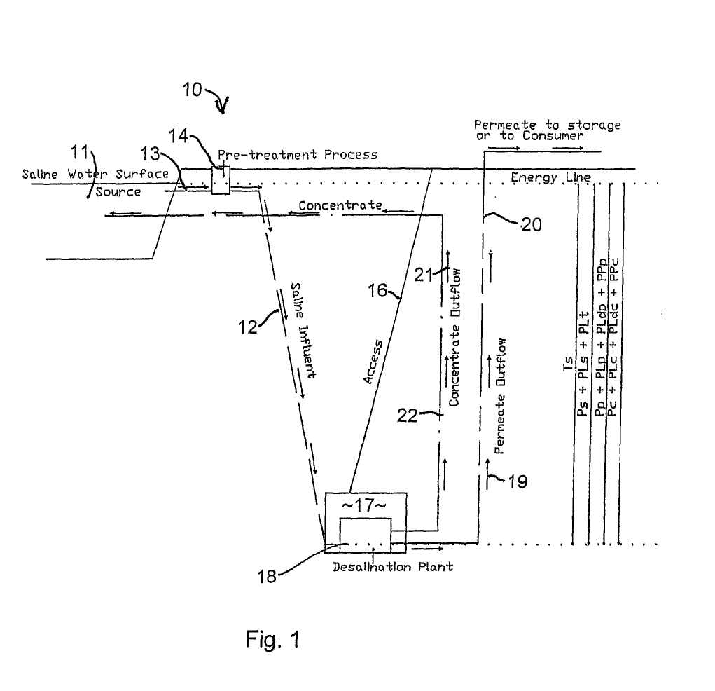

The hydrostatic head reverse osmosis apparatus 10 shown in FIG. 1 includes saline or impure water source 11 from which an influent feedstock may be supplied. This source includes, for example, ocean, lake or river waters, natural or man made storage (dam, reservoir or the like), above and below ground storage, or saline/impure groundwater. An inlet conduit 13 connects the source to the a pre-treatment plant 14 including pumps, pipework, valve, meters, controls; and the like (not shown). The pre-treatment process is provided to remove such materials as suspended solids which may be deleterious to the reverse osmosis process. The pre-treatment process may include addition or removal of chemical species to adjust chemical properties such as acidity, pH, redox and such like. A head feeder conduit 12 provide fluid connection between the pre-treatment plant and a reverse osmosis plant 18 housed in a subterranean chamber 17. If appropriately designed, the hydrostatic pressures losses may be minimised and the pre-treatment plant and head feeder conduit will have minimal impact on the total hydrostatic pressure delivered to the reverse osmosis plant.

An access passage 16 connecting the subterranean chamber to the surface provides access to the reverse osmosis plant and equipment for operation, management and maintenance of purposes. Ventilation, power supply and communications and similar services may be run along the access passage or through one or more alternative passages. Such passages may be vertical or inclined to the vertical in orientation, run alongside one another, or be directed to surface openings at different locations.

The subterranean chamber may be a mine or mine shaft, man made or naturally formed cavity, room, and/or other facility. The chamber is selected or formed to accommodate such plant and equipment as may be required to house the reverse osmosis plant. The reverse osmosis plant includes pipe work, valves, controls, pumps, electronics and equipment operable to control the plant to convert the feedstock into permeate and concentrate using a desalination/filtration/purification process that relies on hydrostatic pressure for its operation.

Permeate from the reverse osmosis plant is pumped by a permeate pump 19 to the surface via a permeate conduit 20. Brine or concentrate, being the saline/impure water outflow from the reverse osmosis plant after some of the water has been removed therefrom is returned to the source via a the concentrate conduit 22 using a concentrate pump interposed between the level of the reverse osmosis plant and the level of the source or disposal location. Permeate may be lifted hydrostatically using energy transferred from residual brine energy.

The reverse osmosis plant may include processes for recovery of energy and thus reduce the power inputs into the system, and thus the cost of producing potable water. The processes for recovery of energy may include an process which relies on the principles in the total process in this invention.

The reverse osmosis plant may include further processing plant for recovery of salts, brine and minerals from the concentrate, using physical, electrical or chemical processes. Materials found in saline water may be recovered using systems including chemical or physical/electrical separation systems known in the art or yet to be developed. The permeate and/or concentrate prior may be processed or part processed prior to delivery to consumers, storage and/or discharge.

Pressures within the reverse osmosis process are maintained by the hydrostatic pressures developed in the column of feedstock on the upstream side of the reverse osmosis plant as well as and the column of concentrate on the downstream side thereof. Pressure in the permeate may be maintained by use of pumps to extract permeate from the system so as to maintain differentials in hydrostatic pressures within the plant required for the reverse osmosis process.

Pressure ‘Ps’ at the entry into the plant 18 may be controlled by altering the pressure ‘PTs’ at the entry into the plant 18 by increasing or decreasing the depth of the plant 18 below the surface of the source 11 or by use of valves and pumps, with due allowances for pressure losses within the pre-treatment plant 14 and the conduit 13 conveying feedstock. The greater the depth of the plant 18 below the surface of the source 11 the higher the hydrostatic pressure exerted on the processes within the plant 18.

The system, processes and methods of this invention are primarily for the production of water suitable for municipal purposes, human and animal consumption, industrial/commercial purposes, irrigation of crops and forests, discharge to the natural and man made environments from a saline or impure source, or a combination of such purposes. The water produced is commonly described as potable water, drinkable water, pure or fresh water. The system, processes and method of the present invention may be applied to any reverse osmosis process.

It will be appreciated that the conduits described herein encompass conduits, pipes, tunnels, shafts or like structures designed to convey feedstock, concentrate, permeate, waste, air or other fluid consumed, produced or used by or within the system. The conduits may be incorporated into the facility in various sizes and combinations and may be contained within each other. Conduits may also be used to hold power supply and communications cables and equipment may be vertical or inclined to the vertical in orientation.

For illustrative purposes, the following parameter terminology is defined:

Pc=Hydrostatic pressure in the concentrate discharged from the plant;

Pp=Hydrostatic pressure in the permeate produced/discharged by the plant;

Ps=Hydrostatic pressure at the inlet to the desalination plant;

Pt=Hydrostatic pressure used within a pre-treatment process for removing deleterious matter within the feedstock prior to delivery to the plant, including controls and other equipment required to manage the pre-treatment process;

Pldc=Pressure loss in the concentrate;

Pldp=Pressure loss in the permeate within the plant;

Plc=Pressure loss in the conduit delivering concentrate;

Plp=Pressure loss in the conduit delivering permeate;

PLs=Pressure loss in the conduit delivering feedstock;

Plt=Pressure loss in the pre-treatment/filtration system;

Ppc=Pumps(s) provided for control of the flow rate of concentrate;

Ppp=Pumps(s) provided for control of the flow rate of permeate;

PTs=Total hydrostatic pressure available to the plant;

Ppu=Pump provided to deliver permeate to storage and/or consumer, can be combined with pumps provided for control of flow (PPc);

Vc=Rate of low of concentrate;

Vs=Rate of flow of feedstock;

Vp=Rate of flow of permeate.

Extraction of permeate from the feedstock using reverse osmosis membrane filtration relies on the feedstock being delivered to the plant generally under relatively high pressures. It is believed that the present invention eliminates the requirement to utilize pumps to generate the relative pressure in the inflow and the back pressure needed to operate the processes within the reverse osmosis plant, although a pump of smaller capacity may be required to provide concentrate flowrates.

This invention utilizes the hydrostatic pressure created by the weight of a column of water connected to the inlet into the reverse osmosis plant to power the reverse osmosis processes. Conservation of energy is obtained by the management of the residual pressures in permeate and concentrate discharged from the reverse osmosis plant to significantly reduce the total energy inputs into the system.

The generalised equations for the process covered by this invention may be summarized as follows:
PTs=Ps+Plt+PLs
PTs=Pp+Plp+Ppp
PTs=Pc+PLc+PPc
Pc=Ps−Pldc
Pp=Ps−Pldc

The above generalised equations do not include allowances for incidental pressure losses and pressure inputs within the plant, controls, pipe work, valves, equipment, fittings and pumps. Nor do the equations include energy recovered by use of work or energy exchangers.

This invention includes the use of pumps located within the system to aid in achieving the flow rates and flow velocities required for the operation of the system and for the management of pressures within the system.

This invention includes the use of control systems to monitor and manage the various, components, pumps, equipment and processes within the system. The control systems may monitor and adjust the feedstock/permeate/concentrate flow rates, saline content of the feedstock and/or concentrate, temperature, pressure and energy used at various locations within the system. The control system(s) may incorporate computers and sensors for detecting, monitoring and measuring data within the system required to manage the process, eg flow rates, hydrostatic pressures, concentrations, temperatures. In addition, the control system may monitor and adjust the rates of flow, concentrations and other physical parameters within the system to minimise the total energy used by the system and consequently the cost of operating the system.

Conventional desalination, purification and/or filtration facilities generally have a more horizontal configuration and require a relatively large ground surface area, or large amount of property, to produce permeate of sufficient quantities and having the required quality. The system in this invention minimises the land surface areas and minimises impacts on the environment and is believed to reduce the cost of producing permeate.

The reverse osmosis system of this invention conserves energy by reducing the energy inputs in the reverse osmosis processes. Naturally generated potential energy is used to generate differential hydrostatic pressures required by the desalination process. The use of natural energy to power the process is how the reverse osmosis system of the present invention conserves energy.

The use of renewable energy sources, such as thermal, solar, wind, biological, chemical or tidal/wave to produce power reduces the dependency on expensive and environmentally unfriendly fossil fuels. In addition use of renewable energy reduces the quantity of pollutants and global warming gases discharged to the environment. Furthermore, the system of this invention may utilise mechanisms to recapture energy produced within the total process and plant.

The total process encompassed by this invention may include equipment and other facilities required to operate and manage the various processes incorporated into the system. Such facilities may include equipment for facilitating access, maintenance, operation of the processes, repairs to the system, alteration to capacity of components of the system, ventilation, communication, safety of personnel, monitoring and other incidental items necessary to manage and control the total system.

The combination of the above components of this invention together may reduce the cost of producing permeate for use, for example, as potable water or for other uses. The land area required for the system may be reduced, and the impacts on the environment may be minimized. The power required for the system may be reduced, and natural potential energy may be converted to hydrostatic pressures required to power the desalination processes.

This invention converts variable long term power costs into a capital cost plus a reduced variable power cost, with significant reduction in environmental impacts.

Although the system and method of this invention has been described and illustrated as desalinating water from a saline or impure water source, it is to be understood that the system in this invention may be used to desalinate, filter and/or purify water from other water sources, as well as encompassing the separation of a solute from a solution.

It is to be understood that the described components of this invention are illustrative and descriptive only and that modifications to the components and equipment in this invention may occur by those skilled in the fields of hydrodynamics, hydraulics, engineering or physics. Accordingly, this invention is not to be regarded as limited to the components disclosed. The system may be adapted to any process for separating salts, ions and chemicals which rely on the application of pressure to generate the process of altering the concentration of the salt, ions and chemicals in the feedstock from an appropriate source. Direct, indirect and differential pressure resulting from the application of the hydrostatic pressure of the feedstock is harnessed to desalinate, filter and/or purify the feedstock using a reverse osmosis process or filtration process singularly or in series, in parallel or tandem, or cascaded.

A work or energy exchanger may be utilised on the permeate outlet where residual pressure is available and/or on the brine or concentrate outlet to recover at least some of the energy from the permeate, brine or concentrate. Such an arrangement may be particularly suited for operation of apparatus according to the invention at locations where sufficient altitude difference for reverse osmosis pressures to be provided by static head is impractical or uneconomical. The recovered energy may be used for augmenting the pressure of the influent feedstock and/or the permeate.

The recovery of energy may be useful in second or subsequent stages of a multi-stage reverse osmosis process by generating or assisting in the generation of part or all of the pressures required for the second or subsequent reverse osmosis processes applied to the permeate or the brine or concentrate. Auxiliary pumps may be provided where required. The brine or concentrate may be pumped to waste, and the permeate may be pumped to the surface, consumer storage or reticulation. The permeate and/or concentrate may be stored in the cavity as hereinbefore described. The selection of the combination of energy recovery and application of hydrostatic head would be based on the inputs and performance parameters of the total process. Moreover, criteria such as economics, environmental impact and such like may also be factored into the selection.

Although the invention has been described with reference to specific examples, it will be appreciated by persons skilled in the art that the invention may be embodied in other forms which are encompassed within the broad scope and ambit of the invention as claimed in the following claims.

1. A method of reverse osmosis using static pressure head which comprises:
providing a feedstock from a feedstock supply in fluid connection with a reverse osmosis plant such that at least some of the feedstock may be passed through the reverse osmosis plant as permeate and remainder of the feedstock may be removed as concentrate to a concentrate delivery in fluid connection with the reverse osmosis plant;
providing a static pressure head in the feedstock and the concentrate by locating the fluid connections between the feedstock and the concentrate and the reverse osmosis plant at respective locations which are vertically displaced from the feedstock supply and the concentrate delivery a distance sufficient to permit the generation of a transmembrane pressure drop for reverse osmosis;
removing the permeate from the reverse osmosis plant in such manner as to permit the transmembrane pressure drop;
removing at least some of the concentrate from the reverse osmosis plant and returning any remaining concentrate to the feedstock; and
locating the concentrate delivery vertically above the reverse osmosis plant such that a back pressure may be generated within the reverse osmosis plant to provide part or all of the transmembrane pressure.

2. A method of reverse osmosis using static pressure head which comprises:
providing a feedstock from a feedstock supply in fluid connection with a reverse osmosis plant, at least some of the feedstock passing through the reverse osmosis plant as permeate and the remainder of the feedstock being removed as concentrate to a concentrate delivery in fluid connection with the reverse osmosis plant;
providing a static pressure head in the feedstock and the concentrate by locating the fluid connections between the feedstock and the concentrate and the reverse osmosis plant at respective locations which are vertically displaced from one the feedstock supply and the concentrate delivery a distance sufficient to permit the static pressure head to contribute to pressure required for the generation of a transmembrane pressure drop for reverse osmosis;
removing the permeate from the reverse osmosis plant in such manner as to permit the transmembrane pressure drop;
removing at least some of the concentrate from the reverse osmosis plant and returning any remaining to the feedstock; and
locating the concentrate delivery vertically above the reverse osmosis plant such that a back pressure may be generated within the reverse osmosis plant to provide part or all of the transmembrane pressure.

3. A method according to claim 1, wherein the static pressure head is provided by locating the reverse osmosis plant in an earth cavity at a depth below ground level or the effective level of the feedstock supply.

4. A method according to claim 1, which further comprises intensifying said static head pressure by pressure generating means.

5. A method according to claim 1, wherein energy recovery is applied to the permeate removed from the reverse osmosis plant.

6. A method according to claim 3, wherein the concentrate is pumped from the earth cavity by a pump located below the ground level or the effective ground level.

7. A method according to claim 3, wherein permeate and/or concentrate is stored below the ground level.

8. A method according to claim 3, which further comprises using part of the static pressure head and/or backpressure to pre-treat the feedstock.

9. A method according to claim 1, wherein two or more reverse osmosis plants are provided in series with one another, the respective fluid connections being arranged for the provision of pressure head from the concentrate of one plant to the feedstock of one or more following reverse osmosis plants.

10. A method according to claim 9, which further comprises supplementing the concentrate fed as feedstock to the or any following reverse osmosis plant with some of the feedstock fed to the first or any previous reverse osmosis plant.

11. A method according to claim 9, which further comprises supplementing the feedstock to the or any preceding reverse osmosis plant with some of the concentrate received from the last or any following reverse osmosis plant.

12. A method according to claim 1, which further comprises intensifying the pressure head of the feedstock, concentrate and/or permeate.

13. A method of reverse osmosis using static pressure head which comprises:
providing a feedstock from a feedstock supply in fluid connection with a reverse osmosis plant such that at least some of the feedstock may be passed through the reverse osmosis plant as permeate and remainder of the feedstock may be removed as concentrate to a concentrate delivery in fluid connection with the reverse osmosis plant;
providing a static pressure head in the feedstock and the concentrate by locating the fluid connections between the feedstock and the concentrate and the reverse osmosis plant at respective locations which are vertically displaced from the feedstock supply and the concentrate delivery a distance sufficient to contribute substantially to the generation of a transmembrane pressure drop for reverse osmosis;
removing the permeate from the reverse osmosis plant in such manner as to permit at least some of the transmembrane pressure drop;
returning at least some of the concentrate to the feedstock;
locating the concentrate delivery vertically above the reverse osmosis plant such that a back pressure may be generated within the reverse osmosis plant to provide part or all of the transmembrane pressure; and
controlling the operation of the reverse osmosis plant by selective adjustment of the backpressure of the concentrate.

14. A method of reverse osmosis using static pressure head which comprises:
providing a feedback from a feedstock supply in fluid connection with a reverse osmosis plant such that at least some of the feedstock may be passed through the reverse osmosis plant as permeate and remainder of the feedstock may be removed as concentrate to a concentrate delivery in fluid connection with the reverse osmosis plant;
providing a static pressure head in the feedstock, the concentrate and the permeate by locating the fluid connections between the feedstock and the concentrate and the reverse osmosis plant at respective locations which are vertically displaced from the feedstock supply and the concentrate delivery a distance sufficient to contribute substantially to the generation of a transmembrane pressure drop for reverse osmosis;
removing the permeate from the reverse osmosis plant in such manner as to permit at least some of the transmembrane pressure drop;
returning at least some of the concentrate to the feedstock; and
controlling the operation of the reverse osmosis plant by selective adjustment of the backpressure applied to the concentrate and the permeate.

15. A method of reverse osmosis using static pressure head which comprises:
providing a feedstock from a feedstock supply in fluid connection with a reverse osmosis plant such that at least some of the feedstock may be passed through the reverse osmosis plant as permeate and remainder of the feedstock may be removed as concentrate to a concentrate delivery in fluid connection with the reverse osmosis plant;
providing a static pressure head in the feedstock, the concentrate and the permeate by locating the fluid connections between the feedstock and the concentrate and the reverse osmosis plant at respective locations which are vertically displaced from the feedstock supply and the concentrate delivery a distance sufficient to contribute substantially to the generation of a transmembrane pressure drop for reverse osmosis;
removing the permeate from the reverse osmosis plant in such manner as to permit the transmembrane pressure drop;
returning at least some of the concentrate to the feedstock; and
controlling the transmembrane pressure drop of the reverse osmosis plant by selective adjustment of the backpressure applied to the concentrate and the permeate.

16. Apparatus for reverse osmosis using static pressure head comprising:
reverse osmosis plant operable to produce a permeate and a concentrate from a feedstock, the feedstock being supplied to the reverse osmosis plant via a feedstock conduit from a feedstock source;
static pressure head means operatively associated with the reverse osmosis plant;
permeate removal means in fluid connection with the reverse osmosis plant for removing permeate from the reverse osmosis plant;
concentrate removal means in fluid connection with the reverse osmosis plant for removing at least some of the concentrate from the reverse osmosis plant to a concentrate removal location, and wherein
the static pressure head means is provided by locating the reverse osmosis plant, the feedstock source and the concentrate removal location at relative altitude differences for generating a static pressure head in the reverse osmosis plant;
the permeate removal means is located whereby, in use, permeate may be removed to provide a transmembrane pressure drop sufficient for reverse osmosis of the feedstock across the membrane or membranes of the reverse osmosis plant;
the location of the brine removal means with respect to the reverse osmosis plant and the feedstock is selected such that, in use, the concentrate removal means may be operated to provide flow of the feedstock sufficient for the generation of an operable fluid velocity across the membrane surface of the reverse osmosis plant, and
the location of the brine removal means with respect to the reverse osmosis plant is selected such that, in use, a backpressure may be applied to the concentrate to control the transmembrane pressure drop.

17. Apparatus for reverse osmosis according to claim 16, wherein the relative elevations of the feedstock concentrate and permeate are selectable for control of cross-membrane velocity of feedstock through the reverse osmosis plant.

18. Apparatus for reverse osmosis according to claim 16, wherein the relative elevations of the feedstock, concentrate and permeate are selectable for control of transmembrane pressure drop through the reverse osmosis plant.

19. A method according to claim 2, wherein the static pressure head is provided by locating the reverse osmosis plant in an earth cavity at a depth below ground level or the effective level of the feedstock supply.

20. A method according to claim 2, which further comprises intensifying said static head pressure by pressure generating means.

21. A method according to claim 2, wherein energy recovery is applied to the permeate removed from the reverse osmosis plant.

22. A method according to claim 19, wherein the concentrate is pumped from the earth cavity by a pump located below the ground level or the effective ground level.

23. A method according to claim 19, wherein permeate and/or concentrate is stored below the ground level.

24. A method according to claim 19, which further comprises using part of the static pressure head and/or backpressure to pre-treat the feedstock.

25. A method according to claim 2, wherein two or more reverse osmosis plants are provided in series with one another, the respective fluid connections being arranged for the provision of pressure head from the concentrate of one plant to the feedstock of one or more following reverse osmosis plants.

26. A method according to claim 25, which further comprises supplementing the concentrate fed as feedstock to the or any following reverse osmosis plant with some of the feedstock fed to the first or any previous reverse osmosis plant.

27. A method according to claim 25, which further comprises supplementing the feedstock to the or any preceding reverse osmosis plant with some of the concentrate received from the last or any following reverse osmosis plant.

28. A method according to claim 2, which further comprises intensifying the pressure head of the feedstock, concentrate and/or permeate.
